(19) United States
(12) Patent Application Publication
(10) Pub. No.: US 2013/0224339 A1
(43) Pub. Date: Aug. 29, 2013

(54) FRUIT SKIN DRINK, FRUIT SKIN BAG, AND DRIED FRUIT SKIN

(71) Applicant: Alice Chang, Los Angeles, CA (US)

(72) Inventor: Alice Chang, Los Angeles, CA (US)

(21) Appl. No.: 13/459,309

(22) Filed: Apr. 30, 2012

Related U.S. Application Data
(60) Provisional application No. 61/602,157, filed on Feb. 23, 2012.

(51) Int. Cl. B65B 29/02; A23L 2/38

(52) U.S. Cl. 426/78; 426/431

(57) ABSTRACT

Fruit skin drink, fruit skin bag, and dried fruit skin (porous bag containing fruit skin fragments for consumption) provides consumers with a healthy food option. Fruit skin drink, fruit skin bag, and dried fruit skin includes at least one porous paper bag having perforations in an exterior surface and an inner volume. The inner volume contains at least one shredded particle of said fruit skin fragments peeled from at least one fruit and dried; and at least one seasoning. The porous bag contains the fruit skin fragments, and the at least one seasoning in combination. The fruit skin fragments provide a user-consumer with vitamins and antioxidants. The fruit is peeled to a depth of about ½ to 1½ mm and then washed to remove dirt and pesticides and dried to form the fruit skin fragments. The fruit skin fragments are sun-dried after removal from the fruit(s).

### CROSS-REFERENCE TO RELATED APPLICATION

The present application is related to and claims priority from prior provisional application Ser. No. 61/602,157, filed Feb. 23, 2012 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of food and beverage compositions and more specifically relates to food and beverage compositions that can be flavored from fruit skin, providing the consumer with healthy vitamins and antioxidants.

2. Description of the Related Art

Many people eat multiple servings of fruit daily in order to replenish their bodies with vitamins and antioxidants. In preparing these snacks, many people first peel the fruit, throw the skin away, and then eat the flesh. Sometimes, though, there can be more nutrients in the skin than in the flesh. However, the skin of some fruit may not be appetizing to eat and may be thick and tough. An efficient and effective way to benefit from the nutrients from fruit skin is necessary.

Various attempts have been made to solve the above-mentioned problems such as those found in U.S. Pat. Nos. 7,485,332; 5,108,774; 7,060,313; 5,238,700; 1,479,329; and 3,112,202. This prior art is representative of food and beverage compositions. None of the above inventions and patents, taken either singly or in combination, is seen to describe the invention as claimed.

Ideally, a food and beverage composition flavored from fruit skin, should be healthy and safe for ingestion and, yet would operate reliably and be produced at a modest expense. Thus, a need exists for a reliable fruit skin drink, fruit skin bag, and dried fruit skin to provide consumers with a healthy food option along with providing an edible way for a consumer to ingest vitamins and antioxidants and to avoid the above-mentioned problems.

### BRIEF SUMMARY OF THE INVENTION

In view of the foregoing advantages inherent in the known food and beverage compositions art, the present invention provides a novel fruit skin drink, fruit skin bag, and dried fruit skin concoction. The general purpose of the present invention, which will be described subsequently in greater detail is to provide consumers with a healthy food option along with providing an edible way for a consumer to ingest vitamins and antioxidants.

Fruit skin drink, fruit skin bag, and dried fruit skin (a porous bag containing fruit skin fragments for consumption) of the present invention provides consumers with a healthy food option. Fruit skin drink, fruit skin bag, and dried fruit skin comprises at least one porous paper (or other material) bag having perforations in an exterior surface and an inner volume. The inner volume contains at least one shredded particle of fruit skin fragments peeled from at least one fruit and dried; and at least one seasoning.

The porous bag contains the fruit skin fragments, and the at least one seasoning in combination. The fruit skin fragments provide a user-consumer with vitamins and antioxidants in a concentrated form. The fruit is preferably initially peeled to a depth of about ½ to 1½ mm and then washed to remove dirt and pesticides and dried to form the fruit skin fragments. The fruit skin fragments are sun-dried after removal from the fruit(s). The porous bag(s) provide prolonged storage means for the fruit skin fragments and the seasoning(s) within an arid atmosphere; the porous bag(s) able to be further stored within a metal container, the container isolating the fruit skin fragments and the seasoning(s) from an ambient atmosphere, and providing the arid atmosphere.

The inner volume of the porous bag contains the fruit skin fragments and the seasoning(s) is accessible by water (when dipped in or otherwise in contact with) ingressing and egressing via the perforations in the exterior surface, the water contacting the fruit skin fragments and the seasoning(s) such that the vitamins and the antioxidants are able to be accessed and dispersed providing flavor and nutrition to at least one prepared health drink for consumption by the user-consumer.

A method of producing a fruit skin vitamin-induced drink, contained in a porous bag, from dried fruit skins, vegetable skins and grain skins comprises the steps of: peeling a fruit to remove a fruit skin (as mentioned above); drying the fruit skin; inserting the fruit skin into the porous bag; boiling the fruit skin in the porous bag for a time period of between 5 and 20 minutes; separating a liquid that is formed from boiling the fruit skin (and/or vegetable, and/or grain skins); storing the liquid in a container; refrigerating the container; serving and consuming the liquid; and adding a desired amount of a seasoning.

The present invention holds significant improvements and serves as a fruit skin drink, fruit skin bag, and dried fruit skin concoction. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, fruit skin drink, fruit skin bag, and dried fruit skin produced and operative according to the teachings of the present invention.

FIG. 1 shows a perspective view illustrating a porous bag, container and fruit as used in a fruit skin drink, fruit skin bag, and dried fruit skin concoction according to an embodiment of the present invention.

FIG. 2 is a perspective view illustrating the porous bag having perforations in an exterior surface for containing the fruit skin drink, fruit skin bag, and dried fruit skin according to an embodiment of the present invention of FIG. 1.

FIG. 3 is a perspective view of porous bag having perforations in an exterior surface stored in a container of the fruit skin drink, fruit skin bag, and dried fruit skin according to an embodiment of the present invention of FIGS. 1 & 2.

FIG. 4 is a perspective view illustrating another view of a (boxed storage) container housing a plurality of porous bags having perforations in an exterior surface of the fruit skin drink, fruit skin bag, and dried fruit skin in a form ready to mix in a beverage according to an embodiment of the present invention of FIG. 1.

FIG. 5 is a flowchart illustrating a method of using for the fruit skin drink, fruit skin bag, and dried fruit skin concoction according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a food and beverage compositions and more specifically relates to food and beverage compositions comprising a healthy food option along with providing an edible way for a consumer to ingest vitamins and antioxidants.

Generally speaking, fruit skin drink, fruit skin bag, and dried fruit skin can allow people to enjoy the nutrients from fruit skin. This unique product can comprise pre-made beverages flavored with fruit skin, a teabag-like bag made from fruit and filled with particles of fruit skin, and dried fruit skin pieces. The outer layer of the fruit can be peeled to a depth of about ½ to 1½ mm and then washed to remove dirt and pesticides. To make the fruit skin drink, the fruit skin can be placed in boiling water for about half an hour to one hour. The liquid can then be separated and placed in containers, which can be made from paper, plastic, metal, or glass. This beverage can be stored in the refrigerator and can be served hot or cold. A mixture or combination of different fruit skins can be used to make each drink. To make shredded particles of fruit skin in fruit skin bags, the fruit skin can be dried and cut into small particles. The particles can be placed in small, porous, sealed bags—similar to tea bags—but made from fruit skin. The fruit skin bag can be placed in a cup with hot boiling water. To make the fruit skin pieces, the fruit skin can be sun dried, dried by heat, or dried by flame, and then cut into small- to medium-sized pieces, if desired.

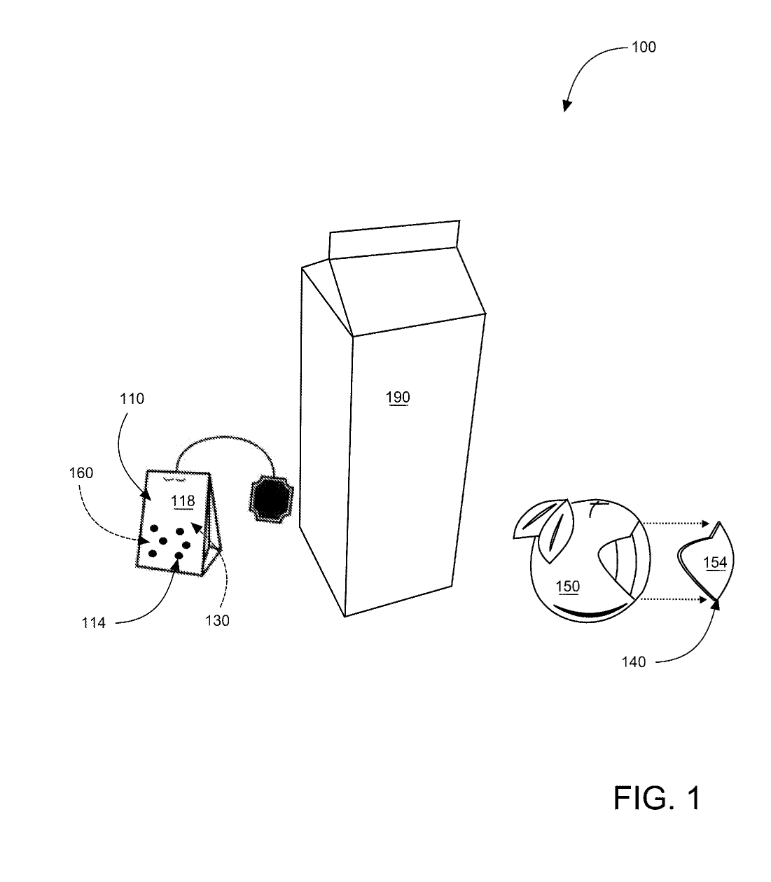

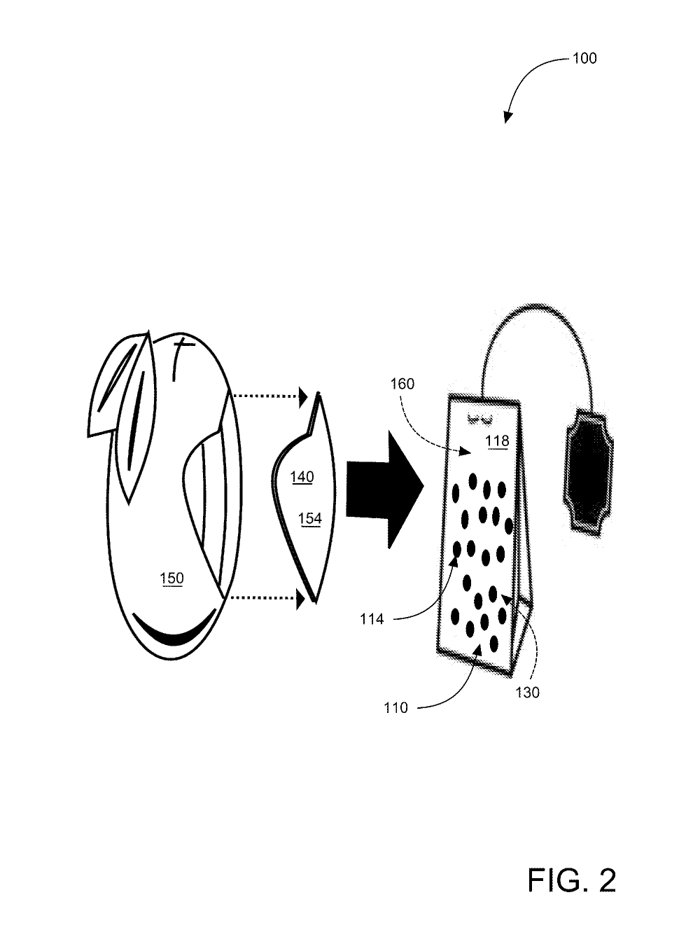

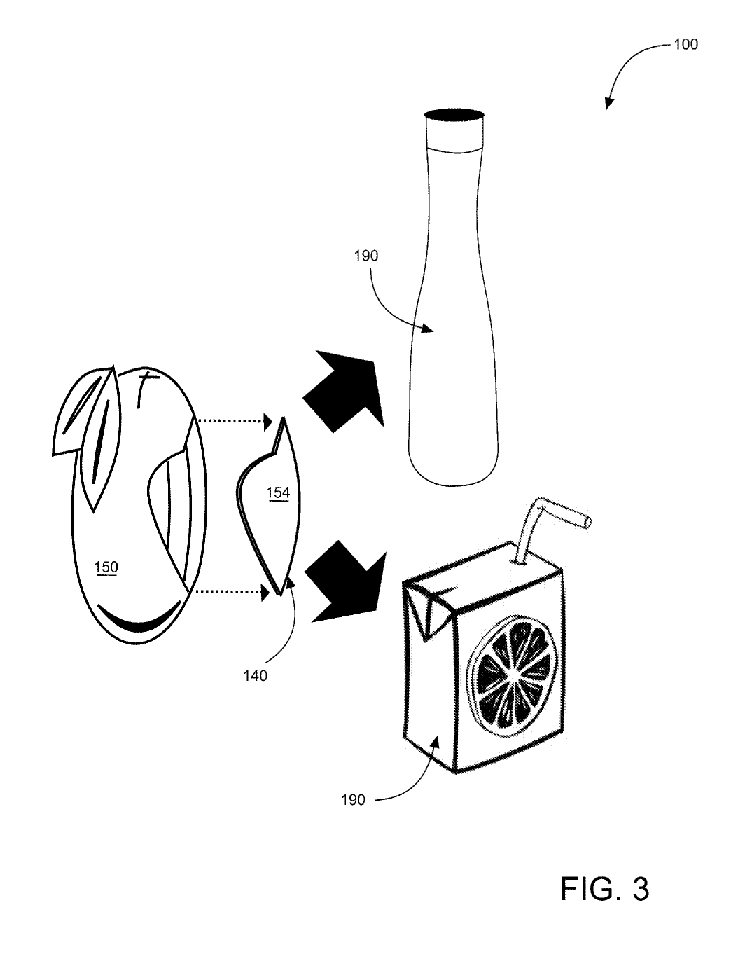

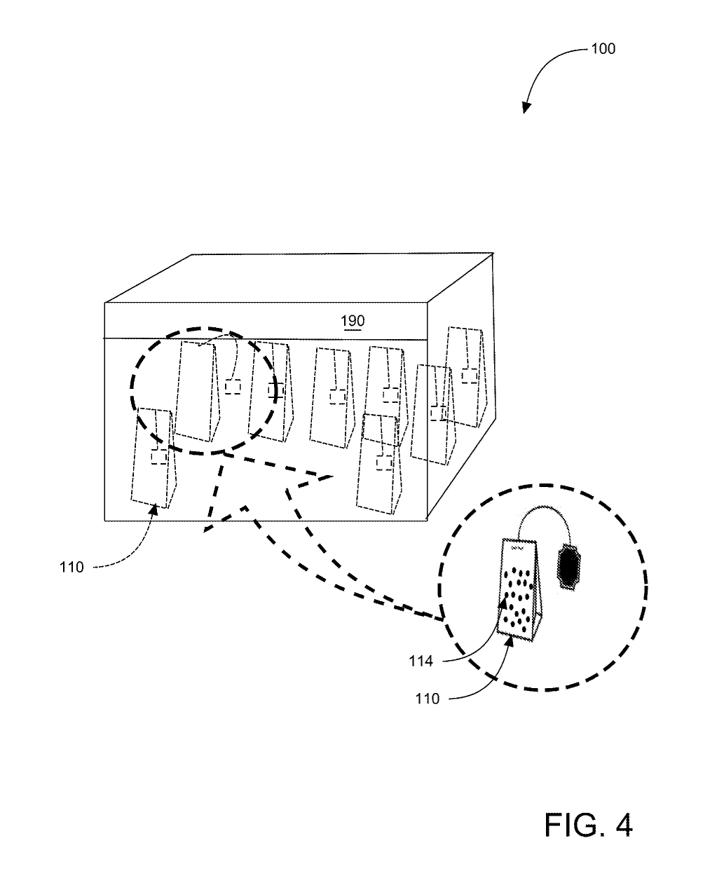

Referring to the drawings by numerals of reference there is shown in FIG. 1-4, showing perspective views illustrating porous bag 110 having perforations 114 in exterior surface 118 of fruit skin drink, fruit skin bag, and dried fruit skin (porous bag containing fruit skin fragments for consumption) 100 in various configurations according to an embodiment of the present invention.

Porous bag containing fruit skin fragments for consumption 100 preferably comprises at least one porous bag 110 having perforations 114 in exterior surface 118 and inner volume 130; inner volume 130 preferably containing: at least one shredded particle of fruit skin fragments 140 peeled from at least one fruit 150 and dried; and at least one seasoning 160. Porous bag 110 contains fruit skin fragments 140, and at least one seasoning 160 in combination. Fruit skin fragments 140 may provide a user-consumer with vitamins and antioxidants via consumption.

Fruit 150 is preferably peeled to a depth of about ½ to 1½ mm and then washed to remove dirt and pesticides and dried to form fruit skin fragments 140. Fruit may include but is not limited to at least one apple, banana, blueberry, cherry, dragon fruit, grape, grapefruit, guava, honeydew, kiwifruit, lemon, lime, lychee, mandarin, mango, nectarine, orange, papaya, peach, pear, plum, pomegranate, pomelo, strawberry, tangerine, and/or watermelon or combination thereof.

In an alternate embodiment fruit 150 may comprises at least one vegetable, such that fruit skin fragments 140 comprise vegetable skin fragments. At least one vegetable skin fragment (botanical fruits) may include but are not limited to at least one tomato, bell pepper, squash, pumpkin, beans, cucumber, peas, or eggplant, Further, fruit 150 may comprises at least one grain, such that fruit skin fragments 140 may comprise grain fragments. Grain fragments may include but are not limited to include rice, wheat, or corn or combination thereof.

Fruit skin fragments 140 may be sun-dried after removal from fruit(s) 150. Upon reading this specification, it should be appreciated that, under appropriate circumstances, considering such issues as user preferences, design preference, structural requirements, marketing preferences, cost, available materials, technological advances, etc., other drying arrangements for the fruit skin fragments may be used such as, for example heat, flame, natural air drying, forced air drying, etc., may be sufficient.

Seasoning 160 may be added to dried fruit skin fragment 140 and may include for example such as salt, sugar, honey, garlic, onion, and pepper or combination thereof. Other seasonings may be available.

Inner volume 130 of porous bag 110 preferably contains fruit skin fragments 140 and seasoning(s) 160 which are accessible by water ingressing and egressing via perforations 114 in exterior surface 118, the water contacting (able to contact; in liquid contact, the potable water acting as a solvent, the water at a high temperature) fruit skin fragments 140 and seasoning(s) 160 such that the vitamins and the antioxidants are able to be accessed and dispersed (diffused into the water) providing flavor and nutrition to at least one prepared health drink for consumption by the user-consumer. Water contact allows the vitamins and the antioxidants to disperse out into the water such that they have a pleasant flavor and are more readily usable by the body of the drinker. Steeping times may vary to obtain a desired concentration and flavor.

Porous bag 110 preferably comprises woven fabric, similar to an existing tea bag. Upon reading this specification, it should be appreciated that, under appropriate circumstances, considering such issues as user preferences, design preference, structural requirements, marketing preferences, cost, available materials, technological advances, etc., other material arrangements for the porous bag such as, for example, paper, silk, plastic, etc., may be sufficient.

Porous bag(s) 110 provide prolonged storage means for fruit skin fragments 140 and seasoning(s) 160 within an arid (substantially controlled) atmosphere, porous bag(s) 110 able to be further stored within container 190 (which may comprise various embodiments as shown); container 190 isolating fruit skin fragments 140 and seasoning(s) 160 from an ambient atmosphere, and providing the preferably arid atmosphere.

Container 190 may comprise metals or non-metals. Upon reading this specification, it should be appreciated that, under appropriate circumstances, considering such issues as user preferences, design preference, structural requirements, marketing preferences, cost, available materials, technological advances, etc., other container material arrangements such as, for example, glass, non-metal such as plastic, paper, etc., may also be sufficient. Also the present invention may be manufactured and sold in different portion sizes and/or sizes/shapes. Various flavorings have been previously mentioned.

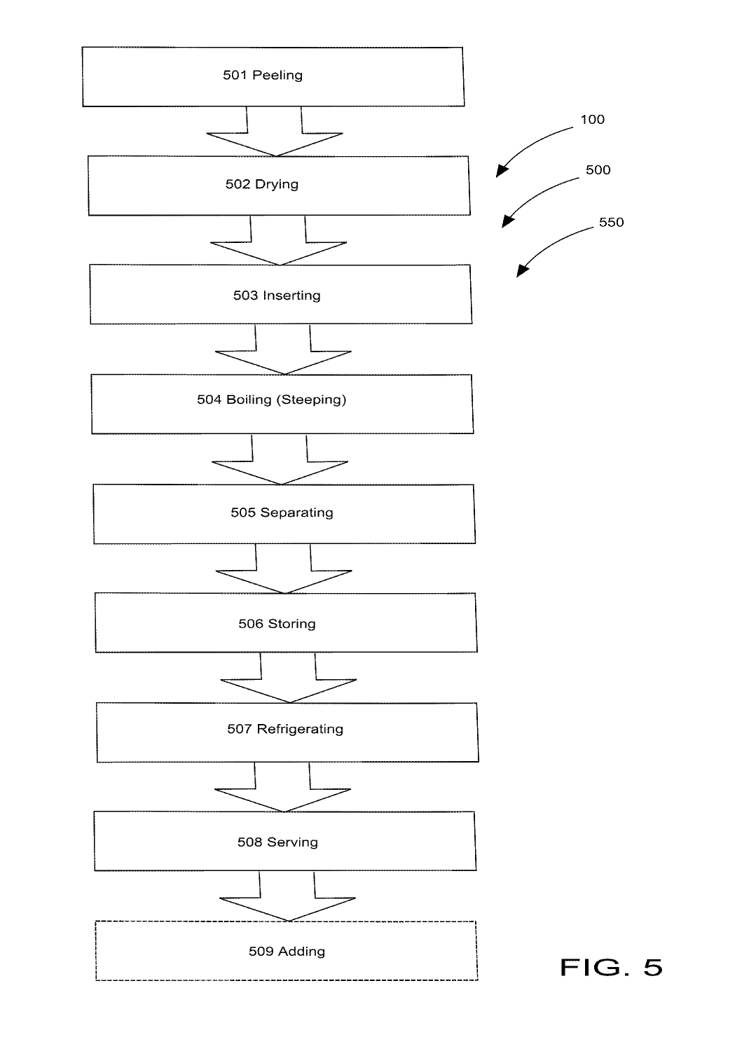

Referring now to FIG. 5, flowchart 550 illustrating a method of using (method of use 500) for the fruit skin drink, fruit skin bag, and dried fruit skin (porous bag containing fruit skin fragments for consumption) 100 according to an embodiment of the present invention of FIGS. 1-4.

A method of producing a fruit skin vitamin-induced drink, contained in porous bag 110, from dried fruit skins, vegetable skins and/or grain skins comprises the steps of: step one 501 peeling fruit 150 to remove fruit skin 154 from fruit 150; step two 502 drying fruit skin 154; step three 503 inserting (packaging) fruit skin 154 into porous bag 110; step four 504 boiling fruit skin 154 in porous bag 110 for a time period of between 5 and 20 minutes (steep times may be varied); step five 505 separating a liquid that is formed from boiling fruit skin 154; step six 506 storing the liquid in container 190; step seven 507 refrigerating container 190; step eight 508 serving and consuming the liquid; and step nine 509 adding a desired amount of seasoning 160 (over and above what is already present in mixture if desired).

It should be noted that step 509 is an optional step and may not be implemented in all cases. Optional steps of method 500 are illustrated using dotted lines in FIG. 5 so as to distinguish them from the other steps of method 500.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A porous bag containing fruit skin fragments for consumption comprising:
at least one porous bag having perforations in an exterior surface and an inner volume, said inner volume containing;
at least one shredded particle of said fruit skin fragments peeled from at least one fruit and dried; and
at least one seasoning;
wherein said porous bag contains said fruit skin fragments, and said at least one seasoning in combination;
wherein said fruit skin fragments provide a user-consumer with vitamins and antioxidants;
wherein said fruit is peeled to a depth of about ½ to 1½ mm and then washed to remove dirt and pesticides and dried to form said fruit skin fragments; and
wherein said inner volume of said porous bag containing said fruit skin fragments and said seasoning(s) is accessible by water ingressing and egressing via said perforations in said exterior surface, said water contacting said fruit skin fragments and said seasoning(s) such that said vitamins and said antioxidants are able to be accessed and dispersed providing flavor and nutrition to at least one prepared health drink for consumption by said user-consumer.

2. The porous bag containing fruit skin fragments for consumption of claim 1 wherein said fruit skin fragments are sun-dried after removal from said fruit(s).

3. The porous bag containing fruit skin fragments for consumption of claim 1 wherein said fruit skin fragments are dried via heat and then cut into said fruit skin fragments.

4. The porous bag containing fruit skin fragments for consumption of claim 1 wherein said fruit skin fragments are dried by a flame and then cut into said fruit skin fragments.

5. The porous bag containing fruit skin fragments for consumption of claim 1 wherein said seasoning(s) comprises salt.

6. The porous bag containing fruit skin fragments for consumption of claim 1 wherein said seasoning(s) comprises sugar.

7. The porous bag containing fruit skin fragments for consumption of claim 1 wherein said seasoning(s) comprises honey.

8. The porous bag containing fruit skin fragments for consumption of claim 1 wherein said seasoning(s) comprises garlic.

9. The porous bag containing fruit skin fragments for consumption of claim 1 wherein said seasoning(s) comprises onion.

10. The porous bag containing fruit skin fragments for consumption of claim 1 wherein said seasoning(s) comprises pepper.

11. The porous bag containing fruit skin fragments for consumption of claim 1 wherein said porous bag comprises paper.

12. The porous bag containing fruit skin fragments for consumption of claim 1 wherein said wherein said porous bag comprises woven fabric.

13. The porous bag containing fruit skin fragments for consumption of claim 1 wherein said porous bag(s) provide prolonged storage means for said fruit skin fragments and said seasoning(s) within an arid atmosphere, said porous bag(s) able to be further stored within a container, said container isolating said fruit skin fragments and said seasoning(s) from an ambient atmosphere, and providing said arid atmosphere.

14. The porous bag containing fruit skin fragments for consumption of claim 13 wherein said container comprises metals.

15. The porous bag containing fruit skin fragments for consumption of claim 13 wherein said container comprises non-metals.

16. The porous bag containing fruit skin fragments for consumption of claim 1 wherein said fruit comprises at least one vegetable, such that said fruit skin fragments comprise vegetable skin fragments.

17. The porous bag containing fruit skin fragments for consumption of claim 1 wherein said fruit comprises at least one grain, such that said fruit skin fragments comprise grain fragments.

18. A porous bag containing fruit skin fragments for consumption comprising:
at least one porous bag having perforations in an exterior surface and an inner volume, said inner volume containing;
at least one shredded particle of said fruit skin fragments peeled from at least one fruit and dried; and
at least one seasoning;
wherein said porous bag contains said fruit skin fragments, and said at least one seasoning in combination;
wherein said porous bag(s) comprises paper;
wherein said porous bag(s) provide prolonged storage means for said fruit skin fragments and said seasoning(s) within an arid atmosphere, said porous bag(s) able to be further stored within a metal container, said container isolating said fruit skin fragments and said seasoning(s) from an ambient atmosphere, and providing said arid atmosphere;
wherein said fruit skin fragments provide a user-consumer with vitamins and antioxidants;
wherein said fruit skin fragments are sun-dried after removal from said fruit(s);
wherein said fruit is peeled to a depth of about ½ to 1½ mm and then washed to remove dirt and pesticides and dried to form said fruit skin fragments;
wherein said fruit comprises at least one vegetable, such that said fruit skin fragments comprise vegetable skin fragments;
wherein said inner volume of said porous bag containing said fruit skin fragments and said seasoning(s) is accessible by water ingressing and egressing via said perforations in said exterior surface, said water contacting said fruit skin fragments, said vegetable skin fragments, and said seasoning(s) such that said vitamins and said antioxidants are able to be accessed and dispersed providing flavor and nutrition to at least one prepared health drink for consumption by said user-consumer.

19. A method of producing a fruit skin vitamin-induced drink, contained in a porous bag, from dried fruit skins, vegetable skins and grain skins comprising the steps of
peeling a fruit to remove a fruit skin;
drying said fruit skin;
inserting said fruit skin into said porous bag;
boiling said fruit skin in said porous bag for a time period of between 5 and 20 minutes;
separating a liquid that is formed from boiling said fruit skin;
storing said liquid in a container;
refrigerating said container; and
serving and consuming said liquid.

20. The method of producing a fruit skin vitamin-induced drink, contained in a porous bag, from dried fruit skins, vegetable skins and grain skins of claim 19 further comprising the step of adding a desired amount of a seasoning.
